(19) United States
(12) Patent Application Publication
(10) Pub. No.: US 2012/0064865 A1
(43) Pub. Date: Mar. 15, 2012

(54) MOBILE TERMINAL AND CONTROL METHOD THEREOF

(76) Inventors: Jinwook Choi, Seoul (KR); Seungwon Lee, Seoul (KR); Seungcheon Baek, Seoul (KR); Jungsu Lea, Seoul (KR)

(21) Appl. No.: 13/147,941

(22) PCT Filed: Sep. 13, 2010
(86) PCT No.: PCT/KR10/06228

§ 371 Date: Aug. 4, 2011

(51) Int. Cl. H04W 4/04

(52) U.S. Cl. 455/414.1

(57) ABSTRACT

A communication terminal includes a wireless communication unit configured to receive a phone event and transmit an indication message, a travel state determining unit configured to determine whether or not a vehicle is traveling based upon vehicle state information when the phone event is received, and a controller configured to transmit an indication message to an originating terminal of the received phone event when it is determined that the vehicle is traveling.

### TECHNICAL FIELD

This disclosure relates to a mobile terminal and a control method thereof.

### BACKGROUND ART

If a mobile terminal receives a call or data, it displays information on the call or a delivery of the data on a screen without considering whether or not a user of the mobile terminal is driving.

### DISCLOSURE OF THE INVENTION

In one aspect, this disclosure is to provide a method for controlling a mobile terminal is described in this disclosure, and the method includes controlling the mobile terminal which receives a phone event while a vehicle having the mobile terminal inside is traveling.

Also in another aspect, this disclosure is to provide a method for notifying a transmitting terminal of a phone event, and the method includes notifying the transmitting terminal, if a mobile terminal receives the phone event while a vehicle having the mobile terminal inside is traveling, that a user of the mobile terminal is driving.

Also in another aspect, this disclosure is to provide a method for notifying a user of a mobile terminal which receives a phone event while a vehicle having a mobile terminal inside is traveling, and the method includes notifying the user without causing any distractions while the vehicle is traveling.

Also in another aspect, this disclosure is to provide a method for determining a travel state of a vehicle having a mobile terminal inside.

The aspects to be disclosed in this disclosure will not be limited to the foregoing aspects, and other technical aspects not mentioned above will be obviously understood by a person skilled in the art disclosed in this disclosure based upon the following description.

To achieve these and other advantages and in accordance with the purpose of the present invention, as embodied and broadly described herein, there is provided a communication terminal including a wireless communication unit configured to receive a phone event and transmit an indication message, a travel state determining unit configured to determine whether or not a vehicle is traveling based upon vehicle state information when the phone event is received, and a controller configured to transmit an indication message to an originating terminal of the received phone event when it is determined that the vehicle is traveling.

The vehicle state information may include at least one of speed information, location information and gear information.

The travel state determining unit may determine that the vehicle is not in a travel state when a reference time has elapsed in a state where the vehicle speed is less than a threshold speed.

The travel state determining unit may determine that the vehicle is not in a travel state when a reference time has elapsed in a state where the vehicle speed is less than a threshold speed and vehicle location information indicates a vehicle waiting area.

The travel state determining unit may determine that the vehicle is not in a travel state when the vehicle gear information indicates park or neutral.

The communication terminal may further include a measuring unit implemented as at least one of a location information module and a motion sensor, and the controller may be configured to obtain the vehicle speed information or the vehicle location information from the measuring unit.

The wireless communicating unit may perform communications with a vehicle terminal or navigation apparatus mounted in the vehicle, and the controller may be configured to obtain the vehicle speed information, the vehicle location information or the vehicle gear information from the vehicle terminal or the navigation apparatus via the wireless communicating unit.

The indication message may include vehicle related information relating to at least one of travel state, arrival point, depart point, current location, travel time and expected travel time.

The indication message may be a voice message or a text message.

The voice message may include predetermined audio data, and the controller may be configured to transmit the voice message to the originating terminal of the phone event when the phone event is a call reception.

The communication terminal may further include a display, the travel state determining unit may determine whether or not the vehicle has stopped based upon the vehicle state information, and the controller may be configured to display at least one of contents, receipt time and originator information related to the received phone event on the display when it is determined that the vehicle has stopped.

The communication terminal may further include an audio output unit, the travel state determining unit may determine whether or not the travel has stopped based upon the vehicle state information, and the controller may be configured to convert at least one of contents, receipt time and originator information of the received phone event into audio data when it is determined that the vehicle has stopped, and output the converted audio data to the audio output unit.

The wireless communicating unit may perform communications with a vehicle terminal mounted in the vehicle, the travel state determining unit may determine whether or not the vehicle has stopped based upon the vehicle state information, and the controller may be configured to convert at least one of contents, receipt time and originator information of the received phone event into audio data when it is determined that the vehicle has stopped, and output the converted audio data to a loud speaker of the vehicle via the vehicle terminal.

The wireless communicating unit may perform communications with a vehicle terminal mounted in the vehicle, the travel state determining unit may determine whether or not the vehicle has stopped based upon the vehicle state information, and the controller may be configured to display at least one of contents, receipt time and originator information of the received phone event on a dashboard of the vehicle or on a front glass of the vehicle via the vehicle terminal when it is determined that the vehicle has stopped.

The wireless communication unit may perform communications with a navigation apparatus mounted in the vehicle, the travel state determining unit may determine whether or not the vehicle has stopped based upon the vehicle state information, and the controller may be configured to transmit at least one of contents, receipt time and originator information of the received phone event to the navigation apparatus when it is determined that the vehicle has stopped.

Meanwhile, to achieve the aspects of this specification, there is provided a method for controlling a communication terminal including receiving a phone event, determining whether or not a vehicle is traveling based upon vehicle state information, and transmitting an indication message to an originating terminal of the received phone event when it is determined that the vehicle is traveling.

The vehicle state information may include speed information, and it is determined that the vehicle is not in a travel state when a reference time has elapsed in a state where the vehicle speed is less than a threshold speed.

The indication message may include vehicle related information relating to at least one of travel state, arrival point, depart point, current location, travel time and expected travel time.

The method may further include determining whether or not the vehicle has stopped based upon the vehicle state information, and visually displaying or audibly outputting at least one of contents, receipt time and originator information of the received phone event when it is determined that the vehicle has stopped.

### ADVANTAGEOUS EFFECT

The communication terminal in accordance with the exemplary embodiment disclosed in this specification can be configured to automatically transmit information indicating that a user of the communication terminal is driving a vehicle to an originator of a phone event when the phone event is received during travel of the vehicle. Accordingly, the user does not have to send an input signal in response to the phone event during driving, thereby providing a service considering the user's safety, who is driving the vehicle.

Also, the communication terminal in accordance with the exemplary embodiment disclosed in this specification can perform a function of indicating a user, which is driving a vehicle, of delivery information related to the received phone event at a safe time, resulting in reduction of a distraction, which may be caused to the user, who is driving, due to the indication of the phone event reception.

### BRIEF DESCRIPTION OF THE DRAWINGS

FIG. 1 is a block diagram illustrating a configuration of a mobile communication terminal having a communication terminal according to an exemplary embodiment disclosed in this specification;

FIG. 2 is a block diagram illustrating a telematics terminal system having a communication terminal according to an exemplary embodiment disclosed in this specification;

FIG. 3 is a block diagram illustrating a configuration of a telematics terminal having a communication terminal according to an exemplary embodiment disclosed in this specification;

FIG. 4 is a view illustrating a configuration of a communication terminal in accordance with an exemplary embodiment;

FIG. 5 is a flowchart illustrating a method for controlling a communication terminal in accordance with an exemplary embodiment;

FIG. 6 is an exemplary view illustrating a method for displaying phone event delivery information in a communication terminal in accordance with an exemplary embodiment;

FIG. 7 is an exemplary view illustrating a method for displaying phone event delivery information in a communication terminal via a vehicle terminal; and

FIG. 8 is a block diagram illustrating a telematics terminal system having a communication terminal applied in accordance with an exemplary variation of this specification.

### MODES FOR CARRYING OUT THE PREFERRED EMBODIMENTS

Terms used in this specification are to facilitate explanation of the scope disclosed in this specification. Thus, it should be understood that the scope of this specification is not limited to the terms used therein.

Reference will now be made in detail to the preferred embodiments, which are illustrated in the accompanying drawings. It will also be apparent to those skilled in the art that various modifications and variations can be made in the present application without departing from the spirit or scope of the invention. Thus, it is intended that the present invention cover modifications and variations of this invention provided they come within the scope of the appended claims and their equivalents.

The like/similar components will have the like/similar reference numerals in the accompanying drawings, and repeated description will be omitted.

The scope of this specification will not be limited to the exemplary embodiments described herein.

Description will now be given in detail of the exemplary embodiments, with reference to the accompanying drawings.

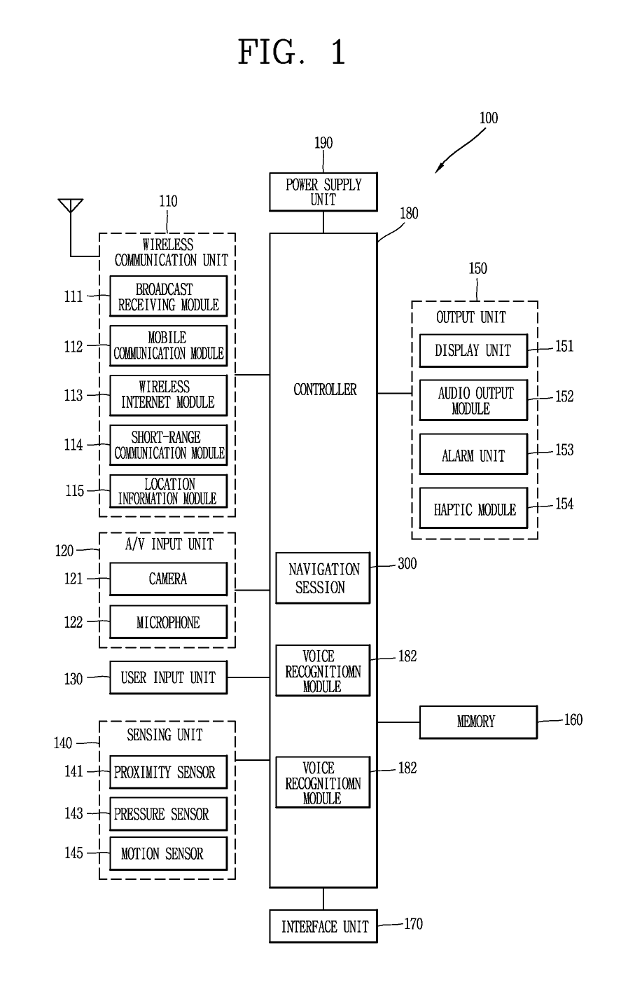

FIG. 1 is a block diagram illustrating a configuration of a mobile communication terminal having a communication terminal according to an exemplary embodiment disclosed in this specification. A suffix “module” or “unit” used for constituent elements disclosed in the following description is merely intended for easy description of the specification, and the suffix itself does not give any special meaning or function.

A mobile communication terminal (mobile phone) 100 disclosed herein may be implemented in various types, examples of which include a portable phone, a smart phone, a laptop computer, a digital broadcast terminal, a personal digital assistant (PDA), a portable multimedia player (PMP), and the like. However, it will be easily understood by a person skilled in the art that the configuration according to the exemplary embodiment of this specification may also be applied to stationary terminals, such as a digital TV, a desktop computer and the like, excluding a case of being applicable only to the mobile communication terminal.

As shown in FIG. 1, the mobile terminal 100 may include a wireless communication unit 110, an Audio/Video (A/V) input unit 120, a user input unit 130, a sensing unit 140, an output unit 150, a memory 160, an interface unit 170, a controller 180, a power supply unit 190, and the like. However, all of the elements as illustrated in FIG. 1 are not necessarily required, and the mobile terminal 100 may be implemented with greater or less number of elements than those illustrated elements.

The wireless communication unit 110 typically includes one or more elements allowing radio communication between the mobile terminal 100 and a wireless communication system, or allowing radio communication between the mobile terminal 100 and a network in which the mobile terminal 100 is located. For example, the wireless communication unit 110 may include a broadcast receiving module 111, a mobile communication module 112, a wireless Internet module 113, a short-range communication module 114, a location information module 115, and the like.

The broadcast receiving module 111 receives broadcast signals and/or broadcast associated information from an external broadcast management server through a broadcast channel. The broadcast channel may include a satellite channel and/or a terrestrial channel. The broadcast management server may mean a server that generates and transmits a broadcast signal and/or broadcast associated information or a server that receives a previously generated broadcast signal and/or broadcast associated information and transmits to the mobile terminal 100. The broadcast signal may include a TV broadcast signal, a radio broadcast signal and a data broadcast signal as well as a broadcast signal in a form that a data broadcast signal is coupled to the TV or radio broadcast signal.

The broadcast associated information may also be provided through a mobile communication network, and in this case, the broadcast associated information may be received by the mobile communication module 112. The broadcast associated information may exist in various forms. For example, it may exist in the form of an electronic program guide (EPG) of digital multimedia broadcasting (DMB), electronic service guide (ESG) of digital video broadcasting-handheld (DVB-H), and the like.

The broadcast receiving module 111 may receive a broadcast signal using various types of broadcast systems. In particular, the broadcast receiving module 111 may receive a digital broadcast signal using a digital broadcast system such as digital multimedia broadcasting-terrestrial (DMB-T), digital multimedia broadcasting-satellite (DMB-S), media forward link only (MediaFLO), digital video broadcast-handheld (DVB-H), integrated services digital broadcast-terrestrial (ISDB-T), and the like. The broadcast receiving module 111 is, of course, configured to be suitable for every broadcast system that provides a broadcast signal as well as the above-mentioned digital broadcast systems. The broadcast signal and/or the broadcast associated information received via the broadcast receiving module 111 may be stored in the memory 160.

The mobile communication module 112 transmits and/or receives a radio signal to and/or from at least one of a base station, an external terminal and a server over a mobile communication network. In this exemplary embodiment, the radio signal may include a voice call signal, a video call signal and/or various types of data according to text and/or multimedia message transmission and/or reception.

The wireless Internet module 113 is a module for supporting wireless Internet access. The wireless Internet module 113 may be built-in or externally installed to the mobile terminal 100. In this exemplary embodiment, the wireless Internet module 113 may use a wireless Internet access technique including a Wireless LAN (WLAN), Wi-Fi, Wireless Broadband (Wibro), World Interoperability for Microwave Access (Wimax), High Speed Downlink Packet Access (HSDPA), and the like.

The short-range communication module 114 is a module for supporting a short-range communication. In this exemplary embodiment, it may be used a short-range communication technology including Bluetooth, Radio Frequency IDentification (RFID), Infrared Data Association (IrDA), Ultra WideBand (UWB), ZigBee, Wireless LAN (protocols such as Bluetooth, 802.11n, etc.) and the like.

The location information module 115 is a module, such as a GPS module, for detecting or calculating a location of the mobile terminal (e.g., capable of checking a current position of a vehicle when the mobile terminal is mounted in the vehicle).

The GPS module may receive position information in cooperation with associated multiple satellites. Here, the position information may include coordinates information represented by latitude and longitude. For example, the GPS module can measure accurate time and distance respectively from more than three satellites so as to accurately calculate a current position of the mobile terminal based on such three different distances according to a triangulation scheme. A scheme may be used to obtain time information and distance information from three satellites and correct error by one satellite. Specifically, the GPS module can further obtain three-dimensional speed information and an accurate time, as well as position on latitude, longitude and altitude, from the position information received from the satellites. Wi-Fi Positioning System and/or Hybrid Positioning System may be applied as the position location module 115.

The A/V input unit 120 is configured to provide audio or video signal input to the mobile terminal. The A/V input unit 120 may include a camera 121 and a microphone 122. The camera 121 receives and processes image frames of still pictures or video obtained by image sensors in a video call mode or a capturing mode. The processed image frames may be displayed on a display 151.

The image frames processed by the camera 121 may be stored in the memory 160 or transmitted to the exterior via the wireless communication unit 110. Two or more cameras 121 may be provided according to the configuration of the mobile terminal.

Further, the microphone 122 receives an external audio signal while the portable device is in a particular mode, such as a phone call mode, recording mode and voice recognition mode. The received audio signal is then processed and converted into digital data. In the calling mode, the processed voice data is converted and outputted into a form capable of transmitting to the mobile communication base station through the mobile communication module 112. Also, the microphone 122 includes assorted noise removing algorithms to remove noise generated in the course of receiving the external audio signal.

The user input unit 130 generates input data responsive to user manipulation of an associated input device or devices. Examples of such devices include a keypad, a dome switch, a touchpad (e.g., static pressure/capacitance), a jog wheel, a jog switch and the like. Especially, if the touchpad has a layered structure with the display 151, it may be referred to as a touch screen.

The sensing unit 140 may generate a sensing signal for controlling operations of the mobile terminal 100 by detecting, for example, an open/close status of the mobile terminal 100, a change of position of the mobile terminal 100 or a component of the mobile terminal 100, a presence or absence of user contact with the mobile terminal 100, orientation or acceleration/deceleration of the mobile terminal 100, etc. As an example, when the mobile terminal 100 is a slide-type mobile terminal, the sensing unit 140 may sense whether a sliding portion of the mobile terminal 100 is open or closed. Other examples include the sensing unit 140 sensing the presence or absence of power provided by a power supply unit 190, the presence or absence of a coupling or other connection between an interface unit 170 and an external device, etc. The sensing unit 140 may further include a proximity sensor 141.

The sensing unit 140 may include a proximity sensor 141, a pressure sensor 143, a motion sensor 145 and the like. The proximity sensor 141 may sense a presence or absence of an object approaching the mobile communication terminal 100, or an object disposed near the mobile communication terminal 100, without a mechanical contact. The proximity sensor 141 may sense an adjacent object by using changes in an alternating magnetic field or a magnetostatic field, or using a rate of change in capacitances or the like. Two or more proximity sensor 142 may be provided depending on a configuration.

The pressure sensor 143 may detect whether pressure is applied to the mobile communication terminal 100, the level of the pressure and the like. The pressure sensor 143 may be installed at a portion required to detect pressure applied thereto in the mobile communication terminal 100 according to use environments. If the pressure sensor 143 is installed in the display 151, a touch input via the display 151 and a pressure touch input by pressure stronger than pressure upon the touch input can be identified according to a signal output from the pressure sensor 143. Also, the level of pressure applied to the display 151 upon the pressure touch input can be recognized according to the signal output from the pressure sensor 143.

The motion sensor 145 may sense location, movement and the like related to the mobile communication terminal 100 using an accelerometer, a gyro sensor or the like. The accelerometer to be used for the motion sensor 145 is a device for converting an acceleration change in one direction into an electric signal. Such accelerometer is widely used with development of Micro-Electromechanical Systems (MEMS) technology. Various types of accelerometers may include a type mounted in an airbag system of a vehicle to measure a high acceleration value for use to sense collision, a type for sensing a fine motion (operation) made by a user's hand(s) to measure a delicate acceleration value for use as an input element of a game, for example, and the like. The accelerometer sensor may be configured by a package with two or three axes, and in some cases, may need merely a Z-axis depending on a usage environment. Hence, even when an X-axial or Y-axial accelerometer other than the Z-axial one is to be used for some reason, the accelerometer may be erected on a main substrate by using a piece substrate for mounting.

The gyro sensor is to measure an angular speed, and may sense a rotated direction with respect to a reference direction.

The output unit 150 is configured to provide an output for audio signal, video signal, or alarm signal, and the output unit 150 may include the display 151, an audio output module 152, an alarm unit 153, and the like.

The display 151 may display (output) information processed in the mobile terminal 100. For example, when the mobile terminal 100 is in a phone call mode, the display 151 may display a User Interface (UI) or a Graphic User Interface (GUI) associated with a call. When the mobile terminal 100 is in a video call mode or image capturing mode, the display 151 may display a captured image and/or received image, a UI or GUI.

The display 151 may include at least one of a Liquid Crystal Display (LCD), a Thin Film Transistor-LCD (TFT-LCD), an Organic Light Emitting Diode (OLED) display, a flexible display, and a three-dimensional (3D) display. Two or more displays 151 may be provided according to a structure of the mobile communication terminal 100. For example, both an external display (not shown) and an internal display (not shown) may be disposed at the mobile communication terminal 100.

In embodiments where the display 151 and a touch sensitive sensor (referred to as ‘touch sensor’) have an interlayer structure, the display 151 may be used as an input device in addition to being used as an output device. The touch sensor may be implemented as a touch film, a touch sheet, a touch pad, and the like, for example.

The touch sensor may be configured to convert changes of a pressure applied to a specific part of the display 151, or a capacitance occurring from a specific part of the display 151, into electric input signals. Also, the touch sensor may be configured to sense not only a touched position and a touched area, but also a touch pressure.

When touch inputs are sensed by the touch sensors, corresponding signals are transmitted to a touch controller (not shown). The touch controller processes the received signals, and then transmits corresponding data to the controller 180. Accordingly, the controller 180 may sense which region of the display 151 has been touched.

A proximity sensor 141 may be arranged at an inner region of the portable terminal 100 covered by the touch screen, or near the touch screen. The proximity sensor may sense a presence or absence of an object approaching a surface to be sensed, or an object disposed near a surface to be sensed, by using an electromagnetic field or infrared rays without a mechanical contact. The proximity sensor has a longer lifespan and a more enhanced utility than a contact sensor.

The proximity sensor may include an optical transmission type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

Hereinafter, a status that the pointer is positioned to be proximate onto the touch screen without contact will be referred to as ‘proximity touch’, whereas a status that the pointer substantially comes in contact with the touch screen will be referred to as ‘contact touch’. When the pointer is positioned in a status of ‘proximity touch,’ the position corresponds to a position to be vertical with respect to the touch screen.

The proximity sensor 141 senses proximity touch, and proximity touch patterns (e.g., distance, direction, speed, time, position, moving status, etc.). Information relating to the sensed proximity touch, and the sensed proximity touch patterns may be output onto the touch screen.

The audio output module 152 may output audio data received from the wireless communication unit 110 or stored in the memory 160, in a call-receiving mode, a call-placing mode, a recording mode, a voice recognition mode, a broadcast reception mode, and so on. The audio output module 152 may output audio signals relating to functions performed in the mobile communication terminal 100, e.g., call signal reception sound, message reception sound, and so on. The audio output module 152 may include a receiver, a speaker, a buzzer, and so on.

The alarm unit 153 outputs signals notifying occurrence of events from the mobile communication terminal 100. The events occurring from the mobile communication terminal 100 may include call signal reception, message reception, key signal input, touch input, and so on. The alarm unit 153 may output not only video or audio signals, but also other types of signals such as signals notifying occurrence of events in a vibration manner. When call signals or messages are received, the alarm unit 153 may implement the mobile communication terminal 100 to vibrate through a vibration means in order to notify the reception. When key signals are input, the alarm unit 153 may implement the mobile communication terminal 100 to vibrate through a vibration means as a feedback to the input. A user can recognize occurrence of events through the vibration of the mobile communication terminal 100. Signals notifying occurrence of events may be output through the display 151 or the audio output module 152.

The haptic module 154 generates various tactile effects. A representative example of the tactile effects generated by the haptic module 154 includes vibration. Vibration generated by the haptic module 154 may have a controllable intensity, a controllable pattern, and so on. For instance, different vibration may be output in a synthesized manner or in a sequential manner.

The haptic module 154 may generate various tactile effects including not only vibration, but also arrangement of pins vertically moving with respect to a skin surface contacting the haptic module 164, air injection force or air suction force through an injection hole or a suction hole, touch by a skin surface, presence or absence of contact with an electrode, effects by stimulus such as an electrostatic force, and reproduction of cold or hot feeling using a heat absorbing device or a heat emitting device.

The haptic module 154 may be configured to transmit tactile effects through a user's direct contact, or a user's muscular sense using a finger or a hand. The haptic module 154 may be implemented in two or more in number according to a configuration of the mobile terminal 100. The haptic module 154 may be located at a position to be frequently contactable with a user in a vehicle, for example, in a steering wheel, a gearshift lever, a seat and the like.

The memory 160 may store programs to operate the controller 180, or may temporarily store input/output data (e.g., music, still images, moving images, map data, and so on).

The memory 160 may be implemented using any type or combination of suitable memory or storage devices including a flash memory type, a hard disk type, a multimedia card micro type, a card type (SD or XD memory), random access memory (RAM), static random access memory (SRAM), electrically erasable programmable read-only memory (EEPROM), programmable read-only memory (PROM), read-only memory (ROM), magnetic memory, magnetic or optical disk, or other similar memory or data storage device. The mobile terminal 100 may operate a web storage on the Internet, or may be operated in relation to a web storage that performs a storage function of the memory 160.

The interface unit 170 interfaces the mobile terminal 100 with all external devices connected to the mobile terminal 100. The interface 170 may include a wire/wireless headset port, an external charger port, a wire/wireless data port, a memory card port, a port to connect a device having a recognition module to the mobile terminal 100, an audio Input/Output (I/O) port, a video Input/Output (I/O) port, an earphone port, and so on. Here, the recognition module is implemented as a chip to store each kind of information to identify an authorization right for the mobile terminal 100, and may include a User Identity Module (UIM), a Subscriber Identity Module (SIM), a Universal Subscriber Identity Module (USIM), and so on. A device having the recognition module (hereinafter, will be referred to as ‘identification device’) may be implemented as a smart card type. Accordingly, the recognition module may be connected to the mobile terminal 100 through a port. The interface unit 170 may be configured to receive data or power from an external device to transmit it to each component inside the mobile terminal 100, or may be configured to transmit data inside the mobile terminal 100 to an external device.

Under a state that the mobile terminal 100 is connected to an external cradle, the interface unit 170 serves as a passage through which power from the external cradle is supplied to the mobile terminal 100, or a passage through which each kind of command signals input from the external cradle is transmitted to the mobile terminal 100. Each kind of command signals or power input from the cradle may serve as signals notifying that the mobile terminal 100 is precisely mounted to the external cradle.

The controller 180 controls an overall operation of the mobile terminal 100. For instance, the controller 180 performs controls and processes relating to data communication, voice call, video call, and the like. The controller 180 may include a multimedia module 181 configured to play multimedia. The multimedia module 181 may be implemented inside the controller 180, or may be separately implemented from the controller 180.

The controller 180 may perform a pattern recognition process to recognize handwriting inputs or picture inputs on the touch screen, as texts or images, respectively.

The power supply unit 190 may be configured to receive external or internal power and to supply the received power to each component of the mobile terminal 100 under control of the controller 180.

In addition, the above various embodiments for the mobile terminal 100 may be implemented in a computer-readable medium using, for example, computer software, hardware, or some combination thereof. For a hardware implementation, the embodiments described above may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In some cases, such embodiments are implemented by the controller 180.

The voice recognition module 182 may recognize user's voice and perform a corresponding function in response to the recognized voice signal.

A navigation session 300 applied to the mobile communication terminal 100 may display a traveling route on map data.

In the meantime, the mobile communication terminal 100 having the communication terminal disclosed in this specification may include a wireless communication unit 110 for receiving a phone event such as a call or data and sending an indication message, an output unit 150 for outputting contents or delivery information related to the received phone event, a measuring unit 115, 145 for measuring location information and speed information related to the communication terminal or a vehicle having the communication terminal mounted therein, a travel state determining unit for determining whether or not the vehicle is traveling (being moved, being driven) based upon state information related to the vehicle (vehicle state information) upon reception of the phone event, and a controller 180 for sending an indication message to an originating terminal of the received phone event if it is determined that the vehicle is traveling, and outputting contents or delivery information of the received phone event onto the output unit if it is determined that the vehicle has stopped. Here, the delivery information related to the phone event may include a receipt time of the phone event and originator information of the phone event.

The travel state determining unit may determine whether or not the vehicle is traveling or has stopped based upon the vehicle state information, such as location information, speed information and the like. To this end, the travel state determining unit may acquire location information and speed information related to the mobile communication terminal 100 from the measuring unit 115, 145 to obtain the state information on the vehicle having the mobile communication terminal 100 mounted therein.

Upon reception of a phone event during travel of the vehicle, a driver of the vehicle as the user of the mobile communication terminal 100 is difficult to respond to the received phone event. Here, the controller 180 may be configured to transmit an indication message to an originating terminal of the phone event without waiting for the user's response to the phone event.

The indication message sent to the originating terminal may include vehicle related information relating to at least one of travel state, arrival point, depart (start) point, current location, travel time and expected travel time. The indication message may be in a format of a voice (audio) message or a text message. The process of transmitting the indication message in the audio message format when the phone event is a call reception may be configured to transmit predetermined voice (audio) data.

The travel state determining unit may be implemented by the controller 180 according to exemplary embodiments. For example, if the travel state determining unit and the controller 180 are implemented in a software configuration, exemplary embodiments such as procedures or functions may be implemented with a separate software module for performing at least one function or operation. Such software code may be implemented by a software application written in an appropriate program language. The software code may alternatively be executed by the controller 180.

The output unit 150 may be the display 151 for visually displaying information related to the phone event or the audio output module 152 for audibly outputting the same. When the output unit 150 is the audio output module 152 of the mobile communication terminal 100, the controller 180 may be configured to convert the contents or delivery information of the phone event into audio data and output the converted audio data onto the audio output module 152 in a sound format.

According to the exemplary embodiment disclosed in this specification, the mobile communication terminal 100 may perform communications with a vehicle terminal 700 mounted in the vehicle via the wireless communication unit 110. The vehicle terminal 700 is an apparatus for performing control of the vehicle having the vehicle terminal 700 or sending the vehicle related information. For example, the vehicle terminal 700 may perform several control operations, such as providing vehicle related information, such as speed, gear state and the like, turning on an emergency light of the vehicle, turning a headlight on/off, determining whether or not a passenger has taken a seat by a sensor installed in a seat within the vehicle, blowing a horn and the like. Also, the vehicle terminal 700 may include a Head-Up Display (HUD) or a projector.

Especially, according to the exemplary embodiment of this specification, the controller 180 of the mobile communication terminal 100 may perform communications with the vehicle terminal 700 to visually or audibly output the contents or delivery information of the phone event, and the travel state determining unit may perform communications with the vehicle terminal 700 to acquire the vehicle state information.

That is, the controller 180 may be configured to convert the contents or delivery information of the phone event into audio data and audibly output the converted audio data in a sound format through a loud speaker of the vehicle via the vehicle terminal 700.

The controller 180 may also be configured to display the contents or delivery information of the phone event on a dashboard of the vehicle via the vehicle terminal 700 or on a front glass of the vehicle using the HUD or projector via the vehicle terminal 700. The HUD may be located in the dashboard of the vehicle. The HUD and the projector may be used in the typically known manner, so detailed description thereof will be omitted.

The travel state determining unit may acquire the vehicle state information not from the measuring unit 115, 145 of the mobile communication terminal 100 but from the vehicle terminal 700 via the wireless communication unit 110. Here, the travel state determining unit may additionally acquire vehicle gear information as the vehicle state information.

The travel state determining unit may determine whether or not the vehicle is in a travel state, especially, moves slow or has stopped based upon the acquired vehicle state information.

The travel state determining unit may determine whether a time longer than a reference time has elapsed in a state that the vehicle speed is less than a threshold speed, whether vehicle location information indicates a waiting area in the state that the vehicle speed is less than the threshold speed, or whether the gear information indicates ‘park’ or ‘neutral.’

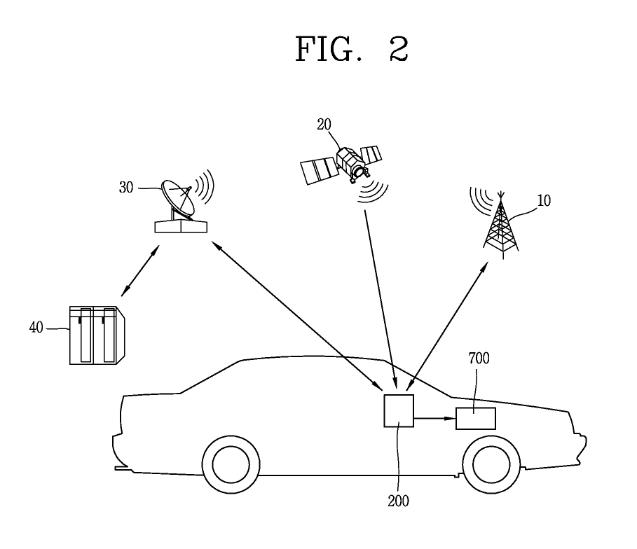

FIG. 2 is a block diagram illustrating a telematics terminal system having a communication terminal according to an exemplary embodiment disclosed in this specification.

As shown in FIG. 2, a vehicle telematics terminal system may include an information providing center 40 for providing traffic information and various data (for example, programs, execution files, etc.), and a telematics terminal 200 mounted in the vehicle for receiving traffic information via a remote wireless communication network 30 and/or a short-range wireless communication network, and providing a road guidance service based upon a GPS signal received via a satellite 20 and the traffic information. Here, examples of the communication network may further include a wired/wireless communication networks, such as a Local Area Network (LAN), a Wide Area Network (WAN) and the like.

Various traffic information (for example, road traffic information or interesting area information) as well as traffic light information are collected via the communication network, and the collected information are processed by the information providing center 40 (for example, a server) according to Transport Protocol Expert Group (TPEG) standard so as to be sent to a broadcasting station. Accordingly, the broadcasting station inserts such traffic information including the traffic light information in a broadcast signal and broadcasts the broadcast signal to the telematics terminal 200. Here, the traffic light information may alternatively be received from a server (not shown) installed in a traffic light when a vehicle approaches the corresponding traffic light.

The server may reconstruct various traffic information, which are collected via different paths connected to the communication network, for example, collected by an operator's input, via a wired/wireless Internet and digital broadcast services, such as Transport Data Channel (TDC) and Multimedia Object Transport (MOC), or from other servers or a probe car, into a traffic information format, such as a format according to the TPEG standard, which is a standard for traffic information services, thereby sending the reconstructed traffic information to the broadcasting station.

The server may thus generate the traffic information format of the TPEG standard including traffic light information to send to the broadcasting station.

The broadcasting station may then load the traffic information including the traffic light information received from the server in a broadcast signal and wirelessly send the broadcast signal to the telematics terminal 200, for example, a navigation apparatus, which is mounted in the vehicle to play a role of a traffic information receiving terminal. The traffic information may include not only the traffic light information but also information related to various traffic conditions, which are required for running vehicles, ships and flights, such as accidents, road conditions, traffic jam, road construction, road block, public traffic network delay, flight delay and the like.

The broadcasting station may receive the traffic information including the traffic light information processed by the server, and send the same to the telematics terminal 200 via a digital signal according to various digital broadcasting standards, examples of which may include European Digital Audio Broadcasting (DAB) based on Eureka-147[ETSI EN 300 401], Digital Multimedia Broadcasting-terrestrial/satellite (DMB-T/S), Digital Video Broadcasting-terrestrial (DVB-T), portable Digital Video Broadcasting-Handheld (DVB-H), Media Forward Link Only (MFLO) and the like.

Also, the broadcasting station may send the traffic information including the traffic light information via a wired/wireless network, such as a wired/wireless Internet.

The vehicle having the telematics terminal 200 indicates any transport of a typical car, bus, train, ship, flight and the like, which are made by employing mechanical and electronic devices for the purpose of carrying or transporting humans or objects.

The vehicle has a traffic information receiving terminal to receive traffic light information from the broadcasting station. The traffic light information is processed to be sent to a user in a graphic, text and/or audio format(s).

The telematics terminal 200 may include a mobile communication module. The mobile communication module may send and receive wireless signals to/from at least one of a base station 10, an external terminal and a server over a mobile communication network. Here, the wireless signals may include a voice call signal, a telephony call signal and/or various types of data in response to transmission/reception of text/multimedia messages.

The telematics terminal 200 may communicate with a vehicle terminal 700 using a wired/wireless communication technology. The vehicle terminal 700 may perform a typical vehicle control, provide vehicle related information such as speed, gear state and the like, turn an emergency light of the vehicle on/off, turn a headlight on/off, determine whether or not a passenger has taken a seat by a sensor installed within a seat in the vehicle, blow a horn and the like. The vehicle terminal 700 may include a HUD or projector.

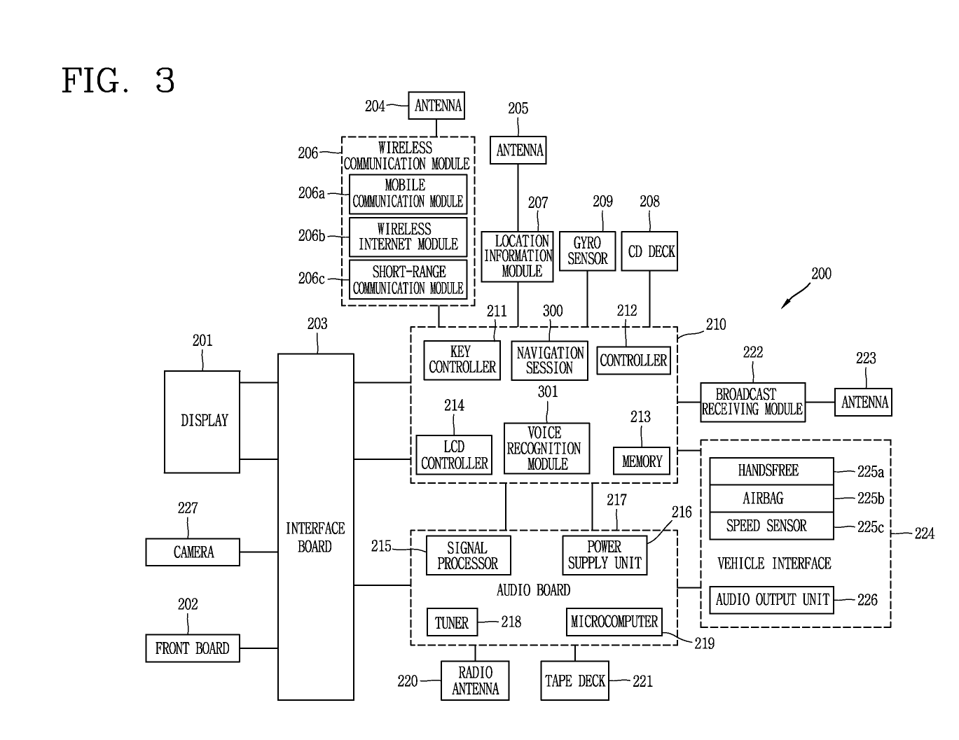

Hereinafter, description will be given of a configuration of the telematics terminal 200 having the communication terminal with reference to FIG. 3.

FIG. 3 is a block diagram illustrating a configuration of a telematics terminal having a communication terminal according to an exemplary embodiment disclosed in this specification.

As shown in FIG. 3, the telematics terminal 200 may include a main board 210. The main board 210 may include a controller (for example, a central processing unit (CPU)) 212 for overall control of the telematics terminal 200, a memory 213 for storing various types of information, a key controller 211 for control of various types of key signals, and a liquid crystal display (LCD) controller 214 for control of LCD.

The memory 213 may store map information (map data) for displaying road guidance information on a digital map. Also, the memory 213 may store a traffic information collection control algorithm for allowing input of traffic information according to road conditions that a vehicle is currently traveling, and information for control of the algorithm.

The main board 210 may include a wireless communication module 206 for performing wireless communications between the telematics terminal 200 and a wireless communication system or between the telematics terminal 200 and a network in which the telematics terminal 200 is present, a location information module 207 for receiving a Global Positioning System (GPS) signal to guide a location of a vehicle, track a traveling route from a depart point to an arrival point, etc., or transmitting traffic information collected by a user using a GPS signal, a compact disk (CD) deck 208 for reproducing a signal recorded on a CD; a gyro sensor 209, and the like. The wireless communication module 206 and the location information module 207 may transmit and receive signals via corresponding antennas 204 and 205, respectively.

The wireless communication module 206 may include a mobile communication module 206a as a mobile communication terminal having a uniquely given device number for transmitting and receiving wireless signals with at least one of a base station, an external terminal and a sever over a mobile communication network, a wireless Internet module 206b for allowing wireless Internet access by technologies, such as Wireless LAN (WLAN), Wi-FI, Wireless broadband (Wibro), World Interoperability for Microwave Access (Wimax), High Speed Downlink Package Access (HSDPA) and the like, and a short-range communication module 206c for performing communications by technologies, such as Bluetooth, Radio Frequency IDentification (RFID), Infrared Data Association (IrDA), Ultra WideBand (UWB), ZigBee, Wireless LAN (protocols such as Bluetooth, 802.11n, etc.) and the like.

The broadcast receiving module 222 may be connected to the main board 210 to receive a broadcast signal via an antenna 223. The main body 210 may be connected, via an interface board 203, with a display (LCD) 201 controlled by the LCD controller 214, a front board 202 controlled by the key controller 211, and a camera 227 for capturing inside and/or outside of the vehicle. The display 201 may display various video signals, text signals and the like. The front board 202 may be provided with buttons for various types of key signal inputs, and provide a key signal corresponding to the user-selected button to the main board 210. Also, the display 201 may include the proximity sensor and the touch sensor (touch screen) shown in FIG. 2.

The front board 202 may include a menu key for allowing direct input of traffic information. The menu key may be controlled by the key controller 211.

An audio board 217 may be connected to the main board 210 to process various audio signals. The audio board 217 may include a microcomputer 219 for control of the audio board 217, a tuner 218 for receiving a radio signal, a power supply unit 216 for supplying power to the microcomputer 219, and a signal processor 215 for processing various audio signals.

The audio board 217 may also include a radio antenna 220 for receiving a radio signal, and a tape deck 221 for reproducing an audio tape. The audio board 217 may further include an audio output unit (for example, amplifier) 226 for outputting an audio (voice) signal processed in the audio board 217.

The audio output unit (amplifier) 226 may be connected to a vehicle interface 224. That is, the audio board 217 and the main board 210 may be connected to the vehicle interface 224. The vehicle interface 224 may also be provided for connection of a handsfree 225a for inputting a voice signal, an airbag 226b for safety of a passenger, a speed (velocity) sensor 225c for detecting the vehicle speed, and the like. The speed sensor 225c may calculate the vehicle speed and provide the calculated speed information to the controller (CPU) 212.

A navigation session 300 applied to the telematics terminal 200 may generate road guidance information based upon map data and current location information related to the vehicle, and notify a user of the generated road guidance information.

The display 201 may detect a proximity touch within a display window via a proximity sensor. For example, the display 201 detects a location of a proximity touch when a pointer (for example, a finger or a stylus pen) generates the proximity touch, and outputs location information corresponding to the detected location to the controller 212.

A voice recognition device (or voice recognition module) 301 may recognize a user's voice, and perform a corresponding function according to the recognized voice signal.

The navigation session 300 applied to the telematics terminal 200 may display a travel path on map data.

Meanwhile, the telematics terminal 200 having the communication terminal may include a wireless communication module 206 for receiving a phone event such as a call or data and sending an indication message, an output unit 201 or 226 for outputting contents or delivery information related to the received phone event, a measuring unit 207, 225c for measuring location information and speed information related to the communication terminal or a vehicle having the communication terminal, a travel state determining unit for determining whether or not the vehicle is traveling based upon vehicle state information upon reception of the phone event, and a controller 212 for sending an indication message to an originating terminal of the phone event if it is determined that the vehicle is traveling, and output contents or delivery information of the phone event to the output unit 201 or 226 if it is determined that the vehicle has stopped. Here, the delivery information related to the phone event may include receipt time and originator information of the phone event.

The travel state determining unit may determine whether or not the vehicle is traveling or has stopped based upon vehicle state information, such as location information, speed information and the like. To this end, the travel state determining unit may acquire location information and speed information related to the telematics terminal 200 from the measuring unit 207, 225c to obtain state information on the vehicle having the telematics terminal mounted therein.

Upon reception of a phone event during travel of the vehicle, a driver of the vehicle as the user of the telematics terminal 200 is difficult to respond to the received phone event. Here, the controller 212 may be configured to send an indication message to an originating terminal of the phone event without waiting for a user's response to the phone event.

The indication message sent to the originating terminal may include vehicle related information relating to at least one of travel state, arrival point, depart (start) point, current location, travel time and expected travel time. The indication message may be in the format of a voice message or text message. The process of transmitting the indication message in the voice message format when the phone event is a call reception may be configured to transmit predetermined voice (audio) data.

The travel state determining unit may be implemented by the controller 212 according to exemplary embodiments. For example, if the travel state determining unit and the controller 212 are implemented in a software configuration, exemplary embodiments such as procedures or functions may be implemented with a separate software module for performing at least one function or operation (procedure). Such software code may be implemented by a software application written in an appropriate program language. The software code may alternatively be executed by the controller 212.

The output unit 201 or 226 may be the display 201 for visually displaying information related to the phone event or the audio output module 226 for audibly outputting the same. When the output unit is the audio output module 226 of the telematics terminal 200, the controller 212 may be configured to convert the contents or delivery information of the phone event into voice (audio) data and output the converted voice data in a sound format via the audio output module 226.

According to the exemplary embodiment disclosed in this specification, the telematics terminal 200 may perform communications with a vehicle terminal 700 mounted in the vehicle via the wireless communication unit 206. The vehicle terminal 700 is an apparatus for performing control of the vehicle having the vehicle terminal 700 or sending the vehicle related information. For example, the vehicle terminal 700 may perform several control operations, such as providing vehicle related information such as speed, gear state and the like, turning an emergency light of the vehicle on/off, turning a headlight on/off, determining whether or not a passenger has taken a seat by a sensor installed in a seat within the vehicle, blowing a horn and the like. Also, the vehicle terminal 700 may include a Head-Up Display (HUD) or a projector.

Especially, according to the exemplary embodiment of this specification, the controller 212 of the telematics terminal 200 may perform communications with the vehicle terminal 700 to visually or audibly output the contents or delivery information of the phone event, and the travel state determining unit may perform communications with the vehicle terminal 700 to acquire the vehicle state information.

That is, the controller 212 may be configured to convert the contents or delivery information of the phone event into audio data and audibly output the converted audio data in a sound format through a loud speaker of the vehicle via the vehicle terminal 700.

The controller 212 may be configured to display the contents or delivery information of the phone event on a dashboard of the vehicle via the vehicle terminal 700 or on a front glass of the vehicle using the HUD or projector via the vehicle terminal 700. The HUD may be located in the dashboard of the vehicle. The HUD and the projector may be used in the typically known manner, so detailed description thereof will be omitted.

The travel state determining unit may acquire the vehicle state information not from the measuring unit 207, 225c of the telematics terminal 200 but from the vehicle terminal 700 via the wireless communication unit 206. Here, the travel state determining unit may additionally acquire vehicle gear information as the vehicle state information.

The travel state determining unit may determine whether or not the vehicle is in a travel (driving) state, especially, moves slow or has stopped based upon the acquired vehicle state information.

The travel state determining unit may determine whether a time longer than a reference time has elapsed in a state that the vehicle speed is less than a threshold speed, whether vehicle location information indicates a waiting area in the state that the vehicle speed is less than the threshold speed, or whether the gear information indicates ‘park’ or ‘neutral.’

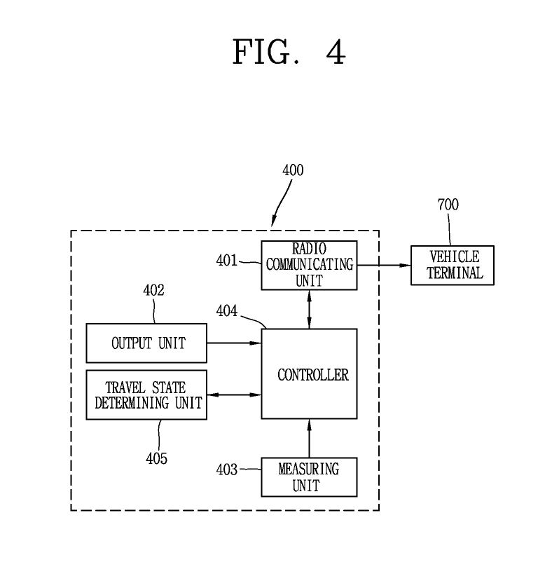

Hereinafter, description will be given of an exemplary configuration of a communication terminal with reference to FIG. 4.

FIG. 4 is a view illustrating a configuration of a communication terminal in accordance with an exemplary embodiment.

As shown in FIG. 4, a communication terminal 400 according to an exemplary embodiment disclosed in this specification may include a wireless communication unit 401 for receiving a phone event such as a call or data and sending an indication message, an output unit 402 for outputting contents or delivery information related to the received phone event, a measuring unit 403 for measuring location information and speed information related to the communication terminal or a vehicle having the communication terminal, a travel state determining unit 405 for determining whether or not the vehicle is traveling based upon vehicle state information upon reception of the phone event, and a controller 404 for sending an indication message to an originating terminal of the phone event if it is determined that the vehicle is traveling, and outputting contents or delivery information related to the phone event to the output unit 402 if it is determined that the vehicle has stopped. Here, the delivery information related to the phone event may include reception time and originator information of the phone event.

The travel state determining unit 405 may determine whether the vehicle is traveling or has stopped based upon vehicle state information, such as location information, speed information and the like. To this end, the travel state determining unit 405 may acquire location information and speed information related to the communication terminal 400 from the measuring unit 403 to obtain state information on the vehicle having the communication terminal 400 mounted therein. Upon reception of a phone event during travel of the vehicle, a driver of the vehicle as the user of the communication terminal 400 is difficult to respond to the received phone event. Here, the controller 404 may be configured to send an indication message to an originating terminal of the phone event without waiting for the user's response to the phone event.

The indication message sent to the originating terminal may include vehicle related information relating to at least one of travel state, arrival point, depart (start) point, current location, travel time and expected travel time. The indication message may be in the format of a voice message or text message. The process of transmitting the indication message in the voice message format when the phone event is a call reception may be configured to transmit predetermined voice data.

The travel state determining unit 405 may be implemented by the controller 404 according to exemplary embodiments. For example, if the travel state determining unit 405 and the controller 404 are implemented in a software configuration, exemplary embodiments of procedures or functions may be implemented with a separate software module for performing at least one function or operation. Such software code may be implemented by a software application written in an appropriate program language. The software code may alternatively executed by the controller 404.

The output unit 402 may be a display for visually displaying information related to the phone event or a speaker for audibly outputting the same. When the output unit is an external speaker of the communication terminal 400, the controller 404 may be configured to convert the contents or delivery information of the phone event into audio data and output the converted audio data in a sound format via the output unit 402.

According to the exemplary embodiment disclosed in this specification, the communication terminal 400 may perform communications with a vehicle terminal 700 mounted in the vehicle via the wireless communication unit 401. The vehicle terminal 700 is an apparatus for performing control of the vehicle having the vehicle terminal 700 or sending the vehicle related information. For example, the vehicle terminal 700 may perform several control operations, such as providing vehicle related information such as speed, gear state and the like, turning an emergency light of the vehicle on/off, turning a headlight on/off, determining whether or not a passenger has taken a seat by a sensor installed in a seat within the vehicle, blowing a horn and the like. Also, the vehicle terminal 700 may include a Head-Up Display (HUD) or a projector.

Especially, according to the exemplary embodiment of this specification, the controller 404 of the communication terminal 400 may perform communications with the vehicle terminal 700 to visually or audibly output the contents or delivery information related to the phone event, and the travel state determining unit 405 may perform communications with the vehicle terminal 700 to acquire the vehicle state information.

That is, the controller 404 may be configured to convert the contents or delivery information related to the phone event into audio data and audibly output the converted audio data in a sound format through a loud speaker of the vehicle via the vehicle terminal 700.

The controller 404 may be configured to display the contents or delivery information of the phone event on a dashboard of the vehicle via the vehicle terminal 700 or on a front glass of the vehicle using the HUD or projector via the vehicle terminal 700. The HUD may be located in the dashboard of the vehicle. The HUD and the projector may be used in the typically known manner, so detailed description thereof will be omitted.

The travel state determining unit 405 may acquire the vehicle state information not from the measuring unit 403 of the communication terminal 400 but from the vehicle terminal 700 via the wireless communication unit 401. Here, the travel state determining unit 405 may additionally acquire vehicle gear information as the vehicle state information.

The travel state determining unit 405 may determine whether the vehicle is in a travel state, especially, moves slow or has stopped based upon the acquired vehicle state information.

The travel state determining unit 405 may determine whether a time longer than a reference time has elapsed in a state that the vehicle speed is less than a threshold speed, whether vehicle location information indicates a waiting area in the state that the vehicle speed is less than the threshold speed, or whether the gear information indicates ‘park’ or ‘neutral.’

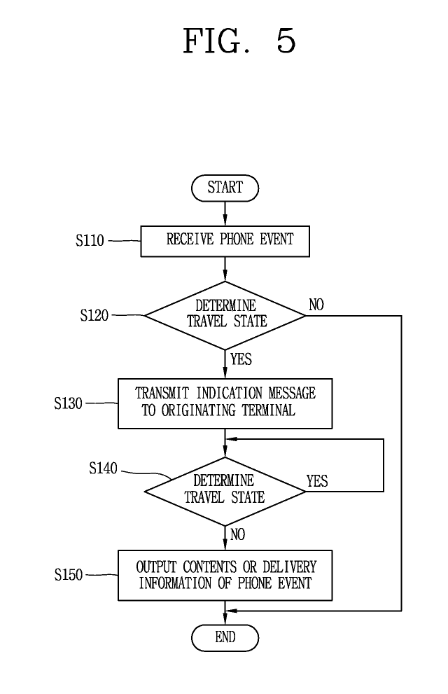

Hereinafter, a method for controlling a communication terminal in accordance with an exemplary embodiment will be described with reference to FIGS. 5 to 7.

The communication terminal 400 disclosed in this specification may be configured to automatically notify to a counterparty that a user (driver) is driving without waiting for the user's response so as to obviate a distraction cause for the user's safety, unlike the typical communication terminal, which does not consider whether or not the user is driving after reception of a phone event. The communication terminal 400 may also be configured to visibly or audibly notify the driver of delivery information related to the phone event when the vehicle has completely or temporarily stopped.

FIG. 5 is a flowchart illustrating a method for controlling a communication terminal in accordance with an exemplary embodiment.

First, upon reception of a phone event in the communication terminal 400, the controller 404 receives the phone event via the wireless communication unit 401 (S110). The phone event, for example, may be a call, a text message, a multimedia message, an e-mail, a chatting and the like.

The travel state determining unit 405 determines whether or not a vehicle is traveling based upon state information related to the vehicle (S120). The vehicle state information may include location information, speed information, gear information and the like.

The travel state determining unit 405 may acquire the state information related to the vehicle having the communication terminal 400 therein by acquiring location information and speed information related to the communication terminal 400 from the measuring unit 403, or acquire the same from the vehicle terminal 700 via the wireless communication unit 401. The vehicle state information acquired via the wireless communication unit 401 may additionally include vehicle gear information.

The communication terminal 400 disclosed in this specification may determine the travel state of the vehicle by way of determining whether or not a reference time has elapsed in a state that the vehicle speed is less than a threshold speed.

The threshold speed may be a predetermined speed, which is faster than a speed that the user walks but slower than a typical travel speed of the vehicle.

The reference time, for example, may be a preset time as long as the user of the communication terminal 400 can safely check the phone event after the vehicle speed is decreased to be less than the threshold speed, other than a case where the vehicle is temporarily moved slowly or stopped.

Also, in determination of the communication terminal 400 as to whether or not the vehicle is traveling according to the exemplary embodiment disclosed in this specification, the travel state determining unit 405 may determine the travel state of the vehicle by way of determining whether or not the vehicle location information indicates a waiting area when the vehicle speed is less than a threshold speed. The waiting area may indicate a geographical range, for example, an area near a stop line for waiting for a signal, an area within a parking lot, a rest area and the like.

Also, the communication terminal 400 may determine the travel state of the vehicle by way of determining whether or not vehicle location information indicates a waiting area when the vehicle speed is less than the threshold speed.

Determining whether or not the vehicle location information indicates the waiting area may be made based upon the acquired vehicle location information and area information on map data corresponding to the vehicle location information. The map data may be acquirable from the mobile communication terminal 100 having the communication terminal 400 applied thereto or the navigation session 300 included in the telematics terminal 200.

Also, the communication terminal 400 may determine the travel state of the vehicle by way of determining whether or not the acquired gear information indicates ‘park’ or ‘neutral.’ The gear information may be obtained from the vehicle terminal 700 via the wireless communication unit 401.

Next, when the controller has determined that the vehicle is traveling, namely, it is considered that the phone event has been received during travel of the vehicle, the communication terminal 400 belonging to the user sends an indication message to the originating terminal of the phone event (S130).

The indication message sent to the originating terminal may include vehicle related information relating to at least one of travel state, arrival point, depart point, current location, travel time and expected travel time. The indication message may be sent in the format of a voice message or a text message.

Upon reception of the phone event in the communication terminal 400, for example, when the phone event is a call reception, the originator of the phone event expects to receive a response from the user of the communication terminal 400 while a ring back tone or ringtone is output. Also, when the phone event is a text message reception, the originator of the text message expects to receive a response text message or a response call to the text message from the user of the communication terminal 400 within a preset time. To this end, the controller 404 may perform a process of sending an indication message, which indicates that the one receiving the phone event is driving, to the originating terminal via a voice or text message.

For example, when the phone event is a call reception, the controller 404 may automatically send a voice message indicating that the vehicle is traveling in response to the call being received. Here, the voice message may be a pre-stored voice message. Alternatively, the controller 404 may send a text message indicating that the vehicle is traveling to the originating terminal of the call without a response to the call being received. Also, even when the phone event is a text message reception, for example, the controller 404 may send a text message indicating that the vehicle is traveling to the originating terminal of the text message.

Next, the travel state determining unit 405 determines whether or not the vehicle is traveling based upon the vehicle state information (S140). After the controller 404 sends the indication message in response to the phone event, which has been received during travel of the vehicle, the travel state determining unit 405 has to determine whether or not the vehicle has stopped to perform the succeeding processes. The process that the travel state determining unit 405 determines whether or not the vehicle has stopped is the same as the step S120, and thus detailed description thereof will not be repeated.

The controller 404 then outputs contents or delivery information of the received phone event to the output unit 402 when it is determined that the vehicle has stopped, namely, the vehicle is not in a travel state (S150). The controller 404 may thus display the delivery information of the phone event on the output unit 402, and especially, output contents of the phone event on the output unit 402 when the phone event is a data reception.

When outputting the delivery information or the like relating to the phone event to the output unit 402 of the communication terminal 400, if the output unit 402 is an external speaker of the communication terminal 400, the controller 404 may be configured to convert the contents or delivery information of the phone event into audio data, and output the converted audio data to the output unit 402 in a sound format.

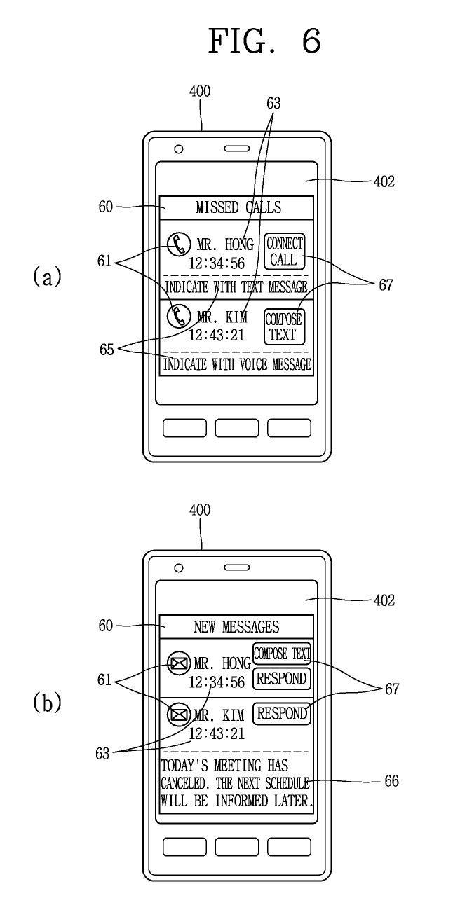

When outputting the delivery information or the like relating to the phone event to the output unit 402 of the communication terminal 400, if the output unit 402 is a display of the communication terminal 400, the controller 404 may be configured to visually display the contents or delivery information of the phone event, method of which will be described later with reference to FIG. 6.

Also, for outputting the contents or delivery information of the phone event according to the exemplary embodiment disclosed in this specification, the controller 404 may perform communications with the vehicle terminal 700 mounted in the vehicle via the wireless communication unit 401.

When performing communications with the vehicle terminal 700 to output the delivery information or the like of the phone event, the controller 404 may be configured to convert the contents or delivery information of the phone event into audio data, and output the converted audio data to a loud speaker of the vehicle in a sound format via the vehicle terminal 700.

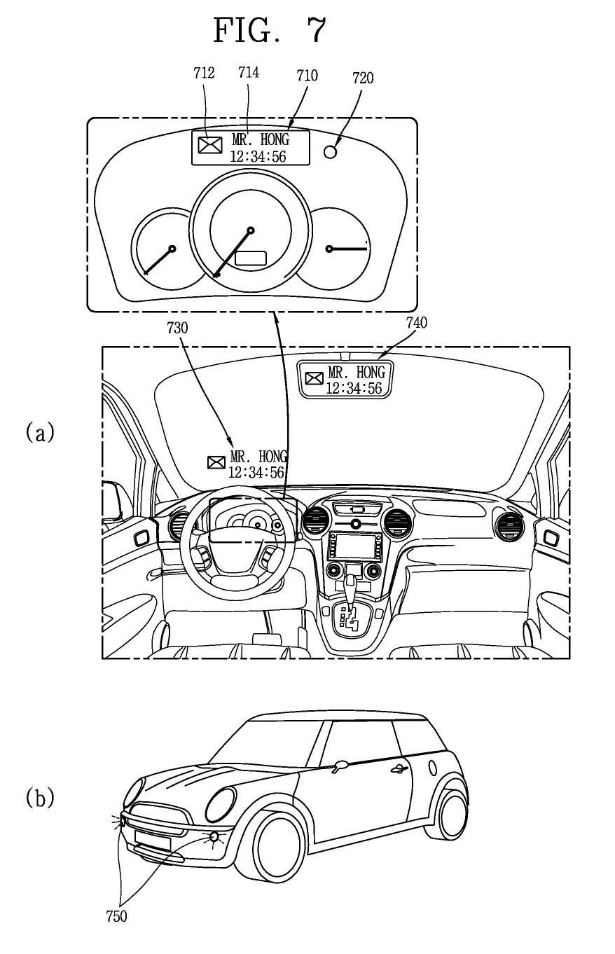

When performing communications with the vehicle terminal 700 to output the delivery information or the like of the phone event, the controller 404 may be configured to display the contents or delivery information of the phone event on a dashboard of the vehicle via the vehicle terminal 700 or on a front glass of the vehicle using a HUD or projector via the vehicle terminal 700, method of which will be described later with reference to FIG. 7.

FIG. 6 is an exemplary view illustrating a method for displaying delivery information related to a phone event in a communication terminal in accordance with an exemplary embodiment.

Prior to displaying the delivery information or the like related to the phone event on a display corresponding to the output unit 402, if a lock function for locking a user's input is set with respect to a sensor connected to the display, the controller 404 of the communication terminal 400 may be configured to perform an unlock process therefor.

The controller 404 may display phone events, for example, missed calls and new messages, on the display corresponding to the output unit 402 according to their types. For example, the controller 404 may display the phone events according to their types by way of displaying on a separate display window 60 output on the output unit 402, or by way of displaying in correspondence with different graphic objects (e.g., icons, etc.) on the display window 60.

The controller 404 may display delivery information 63 of the phone event including an originator of the phone event, a received time thereof and the like.

As performed at Step S130 of FIG. 3, the controller 404, which has received the phone event, may display a transmission result 65 of an indication message including information, which indicates that the user of the communication terminal 400 is driving, to the originating terminal of the phone event.

When the type of phone event received is data such as a text message, the controller 404 may display contents 66 of the received phone event.

Upon displaying the contents or delivery information of the phone event, the controller 404 may display information 67 indicating a short-cut for a process, which is to be performed in correspondence with the phone event. For example, in regard of the list of missed calls, the controller 404 may display a call connecting menu for placing a call with a phone number of the originating terminal of the phone event or a text composing menu for composing a text message to be sent to the originating terminal of the phone event. Also, in regard of the list of new messages, the controller 404 may display a menu for checking contents of a received text message or a menu for composing a text message to be sent as response to the originating terminal of the text message.

FIG. 7 is an exemplary view illustrating a method for displaying delivery information related to a phone event in a communication terminal via a vehicle terminal in accordance with an exemplary embodiment.

The controller 404 of the communication terminal 400 may perform communications with the vehicle terminal 700 mounted in the vehicle via the wireless communication unit 401 in order to output contents or delivery information of the phone event.

The vehicle terminal 700 is an apparatus for performing a control of the vehicle having the vehicle terminal 700 or transmitting information related to the vehicle. For example, the vehicle terminal 700 may perform a typical vehicle control, provide vehicle related information such as speed, gear state and the like, turn an emergency light of the vehicle on/off, turn a headlight on/off, determine whether or not a passenger has taken a seat by a sensor installed within a seat in the vehicle, blow a horn and the like. The vehicle terminal 700 may include a HUD or projector (not shown).

The controller 404 may be configured to output the contents or delivery information of the phone event on a dashboard of the vehicle via the vehicle terminal 700.

A part of the dashboard, for example, may be formed to have a display 710 for displaying information sent from the communication terminal 404, and the controller 404 may be configured to display contents or delivery information 714 related to the phone event on the display 710. The display 710 may be allowed to display information indicating types of phone events, for example, graphic objects (e.g., icons, etc.) for identifying (discriminating) missed calls and new messages.

The dashboard, for example, may have at least one lamp 720 for indicating that the communication terminal 400 has received a phone event, and the controller 404 may be configured to indicate the phone event reception of the communication terminal 400 simply by controlling display characteristics of the lamp 720, for example, flickering or non-flickering, flickering interval, lighting color and the like.

The controller 404 may also control the HUD or projector included in the vehicle terminal 700 to display contents or delivery information of the phone event on a specific region of a front glass of the vehicle.

The output via the vehicle terminal 700 may be executed, with no limit to an output unit formed at the dashboard of the vehicle, by various output modules, such as an indoor glass 740 and the like, formed within the vehicle, and a display module, such as a turning light 750 and the like, formed outside the vehicle. Especially, when the controller 404 is configured to output delivery information of the phone number using the turning light 750, the controller 404 may perform a control operation similar to controlling the lamp 720. The controller 404 may also be configured to perform a control operation by further considering information as to whether there is a person left on a seat of the vehicle, obtained from the vehicle terminal 700.

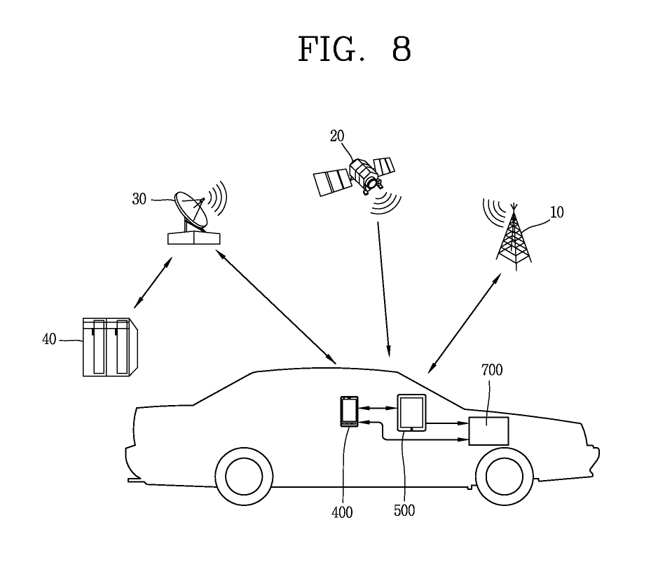

FIG. 8 is a block diagram illustrating a telematics terminal system having a communication terminal in accordance with an exemplary variation of this specification.

As shown in FIG. 8, a telematics terminal system may include an information providing center 40 for providing traffic information and various data, a navigation apparatus 500 mounted in a vehicle for receiving traffic information via a remote wireless communication network 30 and/or a short-range wireless communication network and providing a road guidance service based upon a GPS signal received via a satellite 20 and the traffic information, and a communication terminal 400 for transmitting and receiving wireless signals with a base station 10 on a mobile communication network.

The navigation (vehicle navigation) apparatuses 500 may be divided into an in-dash type and an on-dash type according to the way of being installed in the vehicle. The in-dash type navigation (vehicle navigation) apparatus is a type of being inserted in a certain space assigned within a dashboard of the vehicle to be fixed thereto. The on-dash type navigation apparatus is a type of being placed on the dashboard of the vehicle or mounted near the dashboard using a particular holder so as to be portably detached from the vehicle.

The navigation (vehicle navigation) apparatus 500 according to the exemplary embodiments may include both the in-dash type and on-dash type navigation (vehicle navigation) apparatuses. In addition to those types of apparatuses, the navigation apparatus 500 may be comprise any information processing device, which cooperates with a GPS receiver for receiving a navigation message sent from a GPS satellite within the vehicle to perform a navigation function, the device which can receive and/or process traffic information.

In the variation disclosed in this specification shown in FIG. 8, as compared with the embodiment shown in FIG. 2, the communication terminal 400 may acquire vehicle location information and area information on map data corresponding to the location information from the navigation apparatus 500 via a wireless communication unit of the communication terminal 400.

That is, the communication terminal 400 may also perform communications even with the navigation apparatus 500 as well as the vehicle terminal 700 mounted in the vehicle, via the communication unit 401. Therefore, in accordance with the variation disclosed in this specification, the controller 404 of the communication terminal 400 may perform communications with the navigation apparatus 500 to visually or audibly output contents or delivery information related to the phone event, and the travel state determining unit 405 may perform communications with the navigation apparatus 500 to obtain state information related to the vehicle.

1. A communication terminal comprising:
a wireless communication unit configured to receive a phone event and transmit an indication message;
a travel state determining unit configured to determine whether or not a vehicle is traveling based upon vehicle state information when the phone event is received; and
a controller configured to transmit an indication message to an originating terminal of the received phone event when the vehicle is determined to be traveling.

2. The terminal of claim 1, wherein the vehicle state information comprises speed information of the vehicle, location information of the vehicle or gear information of the vehicle.

3. The terminal of claim 2, wherein the vehicle is determined not to be traveling when a speed of the vehicle based on the speed information has been less than a threshold speed for a reference time period.

4. The terminal of claim 2, wherein the vehicle is determined not to be traveling when a speed of the vehicle has been less than a threshold speed for a reference time period and the location information of the vehicle indicates a vehicle waiting area.

5. The terminal of claim 2, wherein the vehicle is determined not to be traveling when the gear information of the vehicle indicates parking or neutral.

6. The terminal of claim 2, further comprising a measuring unit including a location information module or a motion sensor,
wherein the controller is configured to obtain the speed information of the vehicle or the location information of the vehicle from the measuring unit.

7. The terminal of claim 2, wherein the wireless communicating unit performs communications with a vehicle terminal or navigation apparatus mounted in the vehicle,
wherein the controller is configured to obtain the speed information of the vehicle, the location information of the vehicle or the gear information of the vehicle from the vehicle terminal or the navigation apparatus via the wireless communicating unit.

8. The terminal of claim 1, wherein the indication message comprises vehicle related information relating to travel state, arrival point, depart point, current location, travel time or expected travel time.

9. The terminal of claim 1, wherein the indication message is a voice message or a text message.

10. The terminal of claim 9, wherein the voice message comprises predetermined audio data,
wherein the controller is configured to transmit the voice message to the originating terminal of the phone event when the phone event is a call reception.

11. The terminal of claim 1, further comprising a display,
wherein the travel state determining unit determines whether or not the vehicle has stopped based upon the state information of the vehicle,
wherein the controller is configured to display contents, receipt time or originator information related to the received phone event on the display when the vehicle is determined to have stopped according to the determination.

12. The terminal of claim 1, further comprising an audio output unit,
wherein the travel state determining unit determines whether or not the vehicle has stopped based upon the state information of the vehicle,
wherein the controller is configured to convert contents, receipt time or originator information of the received phone event into audio data, and output the converted audio data to the audio output unit, when the vehicle is determined to have stopped according to the determination.

13. The terminal of claim 1, wherein the wireless communicating unit performs communications with a vehicle terminal mounted in the vehicle,
wherein the travel state determining unit determines whether or not the vehicle has stopped based upon the state information of the vehicle,
wherein the controller is configured to convert contents, receipt time or originator information of the received phone event into audio data, and output the converted audio data to a loud speaker of the vehicle via the vehicle terminal, when the vehicle is determined to have stopped according to the determination.

14. The terminal of claim 1, wherein the wireless communicating unit performs communications with a vehicle terminal mounted in the vehicle,
wherein the travel state determining unit determines whether or not the vehicle has stopped based upon the state information of the vehicle,
wherein the controller is configured to display contents, receipt time or originator information of the received phone event on a dashboard of the vehicle or on a front glass of the vehicle via the vehicle terminal when the vehicle is determined to have stopped according to the determination.

15. The terminal of claim 1, wherein the wireless communication unit performs communications with a navigation apparatus mounted in the vehicle,
wherein the travel state determining unit determines whether or not the vehicle has stopped based upon the state information of the vehicle,
wherein the controller is configured to transmit at least one of contents, receipt time and originator information of the received phone event to the navigation apparatus when the vehicle is determined to have stopped according to the determination.

16. A method for controlling a communication terminal comprising:
receiving a phone event;
determining whether or not a vehicle is traveling based upon state information of the vehicle; and
transmitting an indication message to an originating terminal of the received phone event when the vehicle is determined to be traveling.

17. The method of claim 16, wherein the state information of the vehicle comprises speed information,
wherein the vehicle is determined not to be traveling when a speed of the vehicle based on the speed information has been less than a threshold speed for a reference time period.

18. The method of claim 16, wherein the indication message comprises vehicle related information relating to travel state, arrival point, depart point, current location, travel time or expected travel time.

19. The method of claim 16, further comprising:
determining whether or not the vehicle has stopped based upon the state information of the vehicle; and
visually displaying or audibly outputting contents, receipt time or originator information of the received phone event when the vehicle is determined to have stopped.
